(19) United States
(12) Patent Application Publication
(10) Pub. No.: US 2026/0139102 A1
(43) Pub. Date: May 21, 2026

(54) EMISSION-FREE SILICONE RUBBER COMPOUNDS

(71) Applicant: Nitrochemie Aschau GmbH, Aschau am Inn (DE)

(72) Inventors: Andreas Langreiter, Geratskirchen (DE); Alexis Krupp, Waldkraiburg (DE); Ulrich Pichl, Aschau am Inn (DE)

(21) Appl. No.: 19/120,441

(22) PCT Filed: Oct. 11, 2023
(86) PCT No.: PCT/EP2023/078188

§ 371 Date: Apr. 11, 2025

(30) Foreign Application Priority Data
Oct. 13, 2022 (DE) 10 2022 126 732.6

(51) Int. Cl. C08G 77/58; C08K 5/5445

(52) U.S. Cl. CPC C08G 77/58; C08K 5/5445

(57) ABSTRACT

A composition obtainable by mixing (a) a crosslinker or a crosslinker mixture obtainable by reacting (HX(CR^{c}₂)ₒY(CR^{c}₂)ₒX(CR^{c}₂)ₒ)₄₋ₚSiKₚ, and (b) metal catalyst and (c) amino silane is provided.

### BACKGROUND

The invention relates to a composition for the preparation of silicone rubber compounds comprising a crosslinker, a metal catalyst and an amino silane, and to the use of the composition as a sealant, glue, coating agent, jointing material, potting compound, adhesive and in paints, and to a silicone rubber compound obtainable by curing the composition.

As materials with elastic properties, silicone rubber compounds have a wide range of applications, for example as sealants, jointing materials, coating agents, casting compounds and adhesives for a wide variety of materials such as glass, porcelain, ceramics, stone, plastics, metals, wood, etc. Cold-curing silicone rubber compounds that cure at room temperature are preferably used. They are also known as RTC (room temperature curing) silicone rubber compounds. These can be used, for example, as one-component RTC silicone rubber compounds (RTC-1) or as two-component RTC silicone rubber compounds (RTC-2). RTC-1 silicone rubber compounds are usually plastically deformable mixtures of polyorganosiloxanes with crosslinkable functional groups and suitable crosslinkers (curing agents), which are stored under exclusion of moisture. These mixtures crosslink under the influence of water such as air humidity at room temperature. This process is known as curing of crosslinkers. In the case of RTC-2 silicone rubber compounds, two separately stored compositions are first mixed and the mixture then cures under the influence of water or humidity at room temperature.

In cold-curing silicone rubber compounds, polyorganosiloxanes (silicones) with two or more crosslinkable functional groups are generally used together with polyfunctional curing agents. The α,ω-dihydroxypolyorganosiloxanes are of great importance here as difunctional polyorganosiloxanes. The crosslinkers or curing agents often have hydrolyzable SiX groups. During crosslinking, the X groups are released as leaving groups. Known leaving groups are, for example, alcohols and oximes.

EP 3 392 313 A1 and EP 3 613 803 A1 describe curable silicone rubber compounds, wherein the composition comprises a curing agent (crosslinker) in the form of a silane with corresponding leaving groups (departing groups).

However, such compositions have the disadvantage that the leaving groups, for example alcohols, hydroxycarboxylic acid esters or oximes, diffuse out of the silicone rubber compounds after curing and are thus emitted into the environment. The chemical substances emitted are sometimes harmful to health, often harmful to the environment and frequently have an unpleasant odor. In addition, the emission leads to a loss of mass and volume of the silicone rubber material or sealant. As a rule, there is a mass loss of around 3-4 wt.-%. This can cause a sealant to crack and no longer perform its sealing function optimally.

### SUMMARY OF THE INVENTION

It is therefore the object of the invention to overcome these disadvantages and to provide a composition which cures at room temperature and emits no or as few chemical substances as possible without negatively affecting the desired properties for room-temperature-curing silicone rubber compounds, in particular their storage stability, curability and good adhesion to all common substrates.

### DETAILED DESCRIPTION OF THE PREFERRED EMBODIMENTS

In one embodiment, the invention relates to a composition obtainable by mixing the components
(a) Crosslinker or crosslinker mixture, obtainable by reaction of (HX(CR^{c}₂)ₒY(CR^{c}₂)ₒX(CR^{c}₂)ₒ)₄₋ₚSiKₚ, wherein
   each X independently represents O, NR^{b}, S, or PR^{b},
   each R^{b} independently represents H, trialkylsilyl or a saturated or unsaturated, optionally substituted hydrocarbon residue with 1-16 carbon atoms,
   each Y independently represents a C—C bond, CR^{c}₂, O, NR^{e} or PR^{e}, wherein
   each R^{c} independently represents H or a saturated or unsaturated, optionally substituted hydrocarbon residue having 1-16 carbon atoms,
   each R^{e} independently represents H or a saturated or unsaturated, optionally substituted hydrocarbon residue with 1-16 carbon atoms,
   each K independently represents Cl, OR^{d} or ON═CR^{g}₂,
   each R^{d} independently represents a saturated or unsaturated, optionally substituted hydrocarbon residue having 1-16 carbon atoms,
   each R^{g} independently represents H or a saturated or unsaturated, optionally substituted hydrocarbon residue having 1-16 carbon atoms,
   each o is independently an integer from 1 to 8 and
   p=2 or 3,
(b) Metal catalyst and
(c) Amino silane.

Surprisingly, no or almost no chemical substances are emitted from this composition after curing. On the one hand, this has the advantage that the composition does not release any unpleasant odors during curing and no toxic substances are emitted. Furthermore, emitted substances can negatively influence or destroy the surrounding material of the application, as it is the case, for example, with acetic acid from acetate groups with concrete, steel or marble. This also reduces volume shrinkage. Volume shrinkage is always accompanied by deformation of the composition, which in particular reduces the risk of leaks in the composition according to the invention after the silicone rubber compounds have cured. Reduced volume shrinkage is therefore advantageous, as it improves the technical properties of the composition. At the same time, the composition otherwise has the same good properties as the currently most modern and best RTC silicone rubber compounds, for example with regard to storage stability, curing properties, etc.

A further embodiment of the invention relates to a composition comprising the components
(a) at least one crosslinker of the formula (X(CR^{c}₂)ₒZ(CR^{c}₂)ₒZ(CR^{c}₂)ₒ)Si, wherein
each Z independently represents N, P, N(CR^{c}₂)ₒX or P(CR^{c}₂)ₒX
and X, R^{c} and o are defined as above,
(b) at least one metal catalyst and
(c) at least one amino silane.

A further embodiment of the invention relates to the use of the composition according to the invention for the production of a sealant, glue, coating agent, jointing material, potting compound, adhesive and/or paint.

In addition, one embodiment of the invention relates to a silicone rubber compound obtainable by curing a composition according to the invention, preferably in the presence of water, for example humidity.

Within the meaning of the invention, “crosslinkers” or “curing agents” are understood to mean, in particular, crosslinkable silane compounds which have cleavable groups (so-called leaving groups or departing groups), wherein leaving groups can be covalently bonded to one another. In particular, a leaving group can also be covalently bonded to a residue which remains bonded to the silicon atom of the crosslinker, so that the leaving group continues to be covalently bonded to the silicon after leaving. The term “crosslinker” also includes, in particular, “crosslinker systems”, which may contain more than one crosslinkable silane compound.

In the sense of the invention, a “covalent bond” (also known as an atomic bond or electron pair bond) is understood, as usual, to be a bond between atoms of non-metals in which electron pairs are formed between the atoms and the atoms are thereby held together. A covalent bond can be a single bond (e.g. C—C), a double bond (C═C) or even triple bonds (C≡C). If residues or groups are “covalently bonded to each other”, this means that the residues or groups are “covalently linked” or “covalently bonded to each other”.

“Sealing agents”, “sealant materials”, “sealants” or “sealing compounds” are used synonymously in the present invention and refer to elastic substances applied in liquid to viscous form or as flexible profiles or sheets for sealing a surface, in particular against water, gases or other media. A cured composition according to the invention can preferably be a sealing agent, sealant or sealing compound.

The term “glue” denotes substances that join parts by surface adhesion (adhesion) and/or internal strength (cohesion). This term includes, in particular, adhesive glue, paste, dispersion glues, solvent glues, reaction glues and contact glues.

“Coating agent” means any agent used to coat a surface.

In the sense of the invention, “potting compounds” or “cable potting compounds” are hot or cold processable compounds for potting cables and/or cable accessories.

The term “alkyl group” denotes a saturated hydrocarbon residue. In particular, alkyl groups have the formula —CₙH²ⁿ⁺¹. The term “with 1 to 16 carbon atoms” refers in particular to a hydrocarbon with 1 to 16 carbon atoms. Examples of alkyl groups are methyl, ethyl-, propyl-, butyl-, isopropyl-, iso-butyl-, sec-butyl-, tert-butyl-, n-pentyl- and ethylhexyl. In particular, alkyl groups may also be substituted, even if this is not explicitly stated.

“Straight-chain alkyl groups” denote alkyl groups that do not contain branches. Examples of straight-chain alkyl groups are methyl, ethyl, n-propyl, n-butyl, n-pentyl, n-hexyl, n-heptyl and n-octyl. The terms “group” and “residue” are used synonymously in the present case.

“Branched alkyl groups” denote alkyl groups that are not straight-chain, i.e. in which the hydrocarbon chain in particular has a bifurcation. Examples of branched alkyl groups are isopropyl, iso-butyl, sec-butyl, tert-butyl, sec-pentyl, 3-pentyl, 2-methylbutyl, iso-pentyl, 3-methylbut-2-yl, 2-methylbut-2-yl, neopentyl, ethylhexyl and 2-ethylhexyl.

The term “alkenyl groups” denotes hydrocarbon residues that contain at least one double bond. For example, an alkenyl group with a double bond has in particular the formula-CₙH₂ₙ₋₁. However, alkenyl groups can also have more than one double bond. The number of hydrogen atoms varies depending on the number of double bonds in the alkenyl group. Examples of alkenyl groups are vinyl, allyl, 2-butenyl and 2-hexenyl.

“Straight-chain alkenyl groups” denote alkenyl groups that do not contain any branches. Examples of straight-chain alkenyl groups are vinyl, allyl, n-2-butenyl and n-2-hexenyl.

“Branched alkenyl groups” denote alkenyl groups that are not straight-chain, i.e. in which the hydrocarbon chain in particular has a bifurcation. Examples of branched alkenyl groups are 2-methyl-2-propenyl-, 2-methyl-2-butenyl- and 2-ethyl-2-pentenyl-.

The term “alkynyl groups” denotes hydrocarbon residues that contain at least one triple bond. For example, an alkynyl group with a triple bond has the formula —CₙH₂ₙ₋₃. Alkynyl groups can also contain more than one triple bond. Double and triple bonds may also be present. Examples are ethynyl, propynyl, butynyl or pentynyl. Alkynyl groups can be substituted or unsubstituted and they can be unbranched or branched.

Alkanediyl, alkenediyl or alkynediyl residues are corresponding residues that each have two bonding sites. Accordingly, alkanetriyl, alkentriyl or alkintriyl residues are residues that have three bonding sites.

The terms “aryl groups”, “aryl residues” or “aromatic residues” are understood to mean mono- or polycyclic aromatic residues. “Aromatic” denotes cyclic, planar hydrocarbons with a conjugated, aromatic π-electron system. Aryl groups are, for example, monocyclic (e.g. phenyl), bicyclic (e.g. indenyl, naphthalenyl, tetrahydronapthyl or tetrahydroindenyl) and tricyclic (e.g. fluorenyl, tetrahydroindenyl). fluorenyl, tetrahydrofluorenyl, anthracenyl or tetrahydroanthracenyl) ring systems in which the monocyclic ring system or at least one of the rings in a bicyclic or tricyclic ring system is aromatic. In particular, a C4 to C14 aryl group denotes an aryl group which has 4 to 14 carbon atoms. In particular, aryl groups can also be substituted, even if this is not explicitly stated.

An aromatic group may be monocyclic, bicyclic, tricyclic or polycyclic. An aromatic group may also contain 1 to 5 heteroatoms selected from the group consisting of N, O, and S. These groups are also referred to as heteroaryl groups (see below). Examples of aromatic groups are benzene, naphthalene, anthracene, phenanthrene, furan, pyrrole, thiophene, isoxazole, pyridine and quinoline, wherein in each of the above examples the necessary number of hydrogen atoms is removed to enable incorporation into the corresponding structural formula.

An “aliphatic” residue” is a hydrocarbon residue that is not aromatic. A “cycloalkyl group” or a “cycloaliphatic residue” denotes a monocyclic or polycyclic hydrocarbon residue which is not aromatic. In particular, a cycloalkyl group with 4 to 14 carbon atoms denotes a non-aromatic hydrocarbon ring with 4 to 14 carbon atoms. Cycloalkyl groups can be saturated or partially unsaturated. Saturated cycloalkyl groups are not aromatic and also have no double or triple bonds. In contrast to saturated cycloalkyl groups, partially unsaturated cycloalkyl groups have at least one double or triple bond, although the cycloalkyl group is not aromatic. In particular, cycloalkyl groups may also be substituted, even if this is not specifically indicated.

An “aralkyl group” or “aliphatic-aromatic group/residue” denotes an alkyl group substituted by an aryl group or an aliphatic residue substituted by an aryl group. A “C5 to C15 aralkyl group” denotes in particular an aralkyl group with 5 to 15 carbon atoms, wherein both the carbon atoms of the alkyl group and the aryl group are contained therein. Examples are benzyl and phenylethyl. Aralkyl groups may in particular also be substituted, even if this is not specifically indicated.

A “cyclic ring system” denotes a hydrocarbon ring that is not aromatic. In particular, a cyclic ring system with 4 to 14 carbon atoms denotes a non-aromatic hydrocarbon ring system with 4 to 14 carbon atoms. A cyclic ring system can consist of a single hydrocarbon ring (monocyclic), of two hydrocarbon rings (bicyclic) or of three hydrocarbon rings (tricyclic). In particular, cyclic ring systems can also contain 1 to 5 heteroatoms, preferably selected from the group consisting of N, Si, O, and S. Alicyclic is a residue that is aliphatic and cyclic.

“Saturated cyclic ring systems” are not aromatic and also have no double or triple bonds. Examples of saturated cyclic ring systems are cyclopentane, cyclohexane, decalin, norbornane and 4H-pyran, wherein in the aforementioned examples the necessary number of hydrogen atoms is removed in each case to enable incorporation into the corresponding structural formula. For example, in a structural formula HO—R*—CH₃, wherein R* is a cyclic ring system with 6 carbon atoms, in particular cyclohexane, two hydrogen atoms would be removed from the cyclic ring system, in particular from cyclohexane, in order to allow incorporation into the structural formula.

A “heteroaryl” group, as used herein, denotes a monocyclic or polycyclic aromatic ring, in particular of 5 to 10 ring atoms, wherein one, two, three or four ring atoms are nitrogen, oxygen or sulfur and the remainder is carbon. Heteroaryl groups can be substituted or unsubstituted. If they are substituted, the substituents are as defined above for cycloalkyl.

A “heteroalicyclic residue” or “heterocycloalkyl group” as used herein means a monocyclic or fused ring of 5 to 10 ring atoms containing one, two or three heteroatoms selected from N, O and S, wherein the balance of the ring atoms is carbon. A “heterocycloalkenyl” group also contains one or more double bonds. However, the ring does not have a complete conjugated π-electron system. When substituted, the substituents are as defined above for cycloalkyl. Unless otherwise specified, N denotes in particular nitrogen. Furthermore, O denotes in particular oxygen, unless otherwise specified.

“Optionally substituted” means that hydrogen atoms in the corresponding group or in the corresponding residue may be replaced by substituents. In particular, substituents may be selected from the group consisting of C1 to C4 alkyl, methyl, ethyl, propyl, butyl, phenyl, benzyl, halogen, fluorine, chlorine, bromine, iodine, hydroxyl, amino, alkylamino, dialkylamino, C1 to C4 alkoxy, phenoxy, benzyloxy, cyano, nitro and thio. If a group is designated as optionally substituted, 0 to 50, in particular 0 to 20, hydrogen atoms of the group may be replaced by substituents. If a group is substituted, at least one hydrogen atom is replaced by a substituent.

“Alkoxy” denotes an alkyl group that is linked to the main carbon chain via an oxygen atom.

The term “polysiloxane” or “polyorganosiloxane” denotes an organosilicone compound.

In the sense of the invention, “silicone rubber compounds” are synthetic silicone-containing rubber compounds, which are also referred to synonymously as (curable) compositions or silicone compositions in the context of the present invention, which includes rubber polymers, polycondensates and polyadducts which can be converted to the highly elastic, cured state by crosslinking with suitable crosslinkers. Furthermore, these are plastically mouldable mixtures, for example of α,ω-dihydroxypolyorganosiloxanes and suitable curing agents or crosslinkers, which can be stored under exclusion of moisture, wherein these silicone rubber compounds polymerize under the influence of water or air humidity at room temperature.

The term “catalyst” denotes a substance that reduces the activation energy of a particular reaction and thereby increases the reaction rate. In the sense of the invention, a metal catalyst is understood to be a compound containing a metal or semi-metal atom or ion. This can be, for example, a salt or an organometallic compound.

The “elongation at break” is the ratio of the change in length to the initial length after the test specimen has broken. It expresses the ability of a material to withstand changes in shape without cracking. The elongation at break is determined according to DIN EN ISO 8339 and DIN 53504 in a tensile test.

The “elongation stress value” defines the stress that is exerted on the bonding surfaces or the adjacent building material when the sealant is 100% elongated.

The “secant modulus” is the ratio of stress to strain at any point on the curve of a stress-strain diagram. It is the slope of a curve from the beginning to any point on the stress-strain curve.

The “resilience” describes the tendency of a flexible beam to fully or partially return to its original dimensions after the forces that caused the expansion or deformation have been removed. The average resilience is determined in accordance with DIN EN ISO 7389.

In one embodiment, the invention relates to a composition obtainable by mixing the components
(a) Crosslinker or crosslinker mixture, obtainable by reaction of (HX(CR^{c}₂)ₒY(CR^{c}₂)ₒX(CR^{c}₂)₄₋ₚSiKₚ, wherein
   each X independently represents O, NR^{b}, S, or PR^{b},
   each R^{b} independently represents H, trialkylsilyl or a saturated or unsaturated, optionally substituted hydrocarbon residue with 1-16 carbon atoms,
   each Y independently represents a C—C bond, CR^{c}₂, O, NR^{e} or PR^{e}, wherein
   each R^{c} independently represents H or a saturated or unsaturated, optionally substituted hydrocarbon residue having 1-16 carbon atoms,
   each R^{e} independently represents H or a saturated or unsaturated, optionally substituted hydrocarbon residue with 1-16 carbon atoms,
   each K independently represents Cl, OR^{d} or ON═CR^{g}₂,
   each R^{d} independently represents a saturated or unsaturated, optionally substituted hydrocarbon residue having 1-16 carbon atoms,
   each R^{g} independently represents H or a saturated or unsaturated, optionally substituted hydrocarbon residue having 1-16 carbon atoms,
   each o is independently an integer from 1 to 8 and
   p=2 or 3,
(b) Metal catalyst and
(c) Amino silane.

In a preferred embodiment, K represents Cl, OR^{d} or ON═CR^{g}₂, in particular OR^{d}. Particularly preferably, the invention relates to a composition obtainable by mixing the components
(a) Crosslinker or crosslinker mixture, obtainable by reaction of (HX(CR^{c}₂)ₒY(CR^{c}₂)ₒX(CR^{c}₂)ₒ)₄₋ₚSi(OR^{d})ₚ, wherein
   X, Y, R^{c}, R^{d} and o are as defined above, and
   p=2 or 3,
(b) Metal catalyst and
(c) Amino silane.

In the reaction of (HX(CR^{c}₂)ₒY(CR^{c}₂)ₒX(CR^{c}₂)ₒ)₄₋ₚSiKₚ, preferably (HX(CR^{c}₂)ₒY(CR^{c}₂)ₒX(CR^{c}₂)ₒ)₄₋ₚSi(OR^{d})ₚ, the residues K, preferably OR^{d}, are nucleophilic substituted by X or Y, thus producing intramolecular chelate-like compounds or compounds in which Si atoms are intermolecularly bonded to one another via the residues HX(CR^{c}₂)ₒY(CR^{c}₂)ₒX(CR^{c}₂)ₒ. As a result, the compounds surprisingly remain for the most part in the sealant matrix after polymerization and/or crosslinking with, for example, polyorganosiloxanes (HO—(SiR^{q}R^{r}O)ₛ—H) to form sealants. Without being bound to them according to the invention, it is assumed that the compounds are still partially bound to Si atoms and thus bound in the polymer, and/or are less volatile due to hydrogen bonds, as they are held by the polar components of the sealant matrix. Both lead to the advantage of low emission of undesirable compounds.

The reactions of (HX(CR^{c}₂)ₒY(CR^{c}₂)ₒX(CR^{c}₂)ₒ)₄₋ₚSiZₚ, preferably (HX(CR^{c}₂)ₒY(CR^{c}₂)ₒX(CR^{c}₂)ₒ)₄₋ₚSi(OR^{d})ₚ, are shown below by way of examples, wherein both preferred reaction pathways to monomeric compounds and reaction pathways to oligomeric compounds are shown. Both lead to the desired result of a low-emission sealant.

In the reaction and oligomerization scheme DTC (part 1) shown below, the reaction of a trimethoxysilane alkylene triamine is shown as an example, in which the nucleophilic substitution of the methoxy groups on the silicon preferably takes place intramolecularly. The conversion to DTC is shown in the middle:

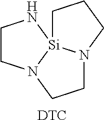

The left and right reaction pathways in part 1 of the reaction and oligomerization scheme DTC shows further intra- and intermolecular reaction possibilities. Part 2 of the reaction and oligomerization scheme DTC shows further possible reactions of the dimeric product A from the part of the scheme. Here, too, all these reaction products and further reaction products thereof can function as crosslinker or crosslinker mixture (a) according to claim 1 and lead to the described advantages of low emission of leaving groups of the crosslinker or crosslinker mixture.

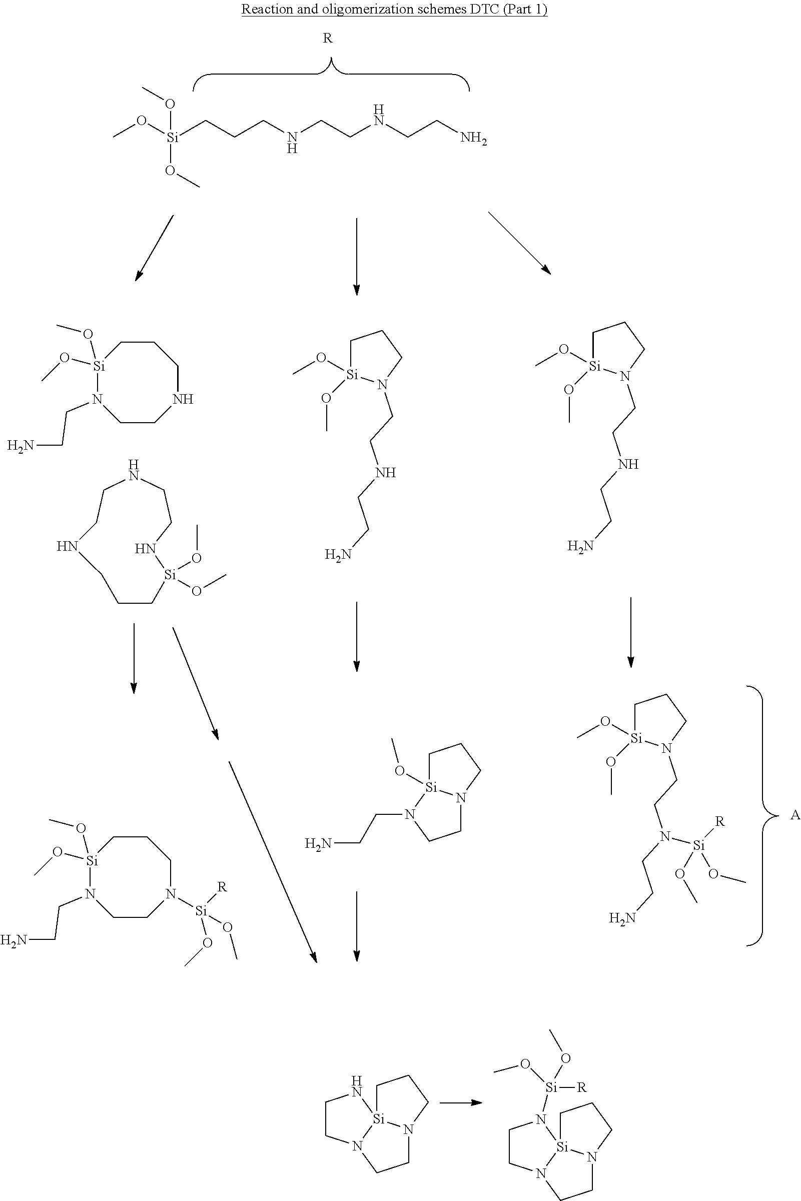

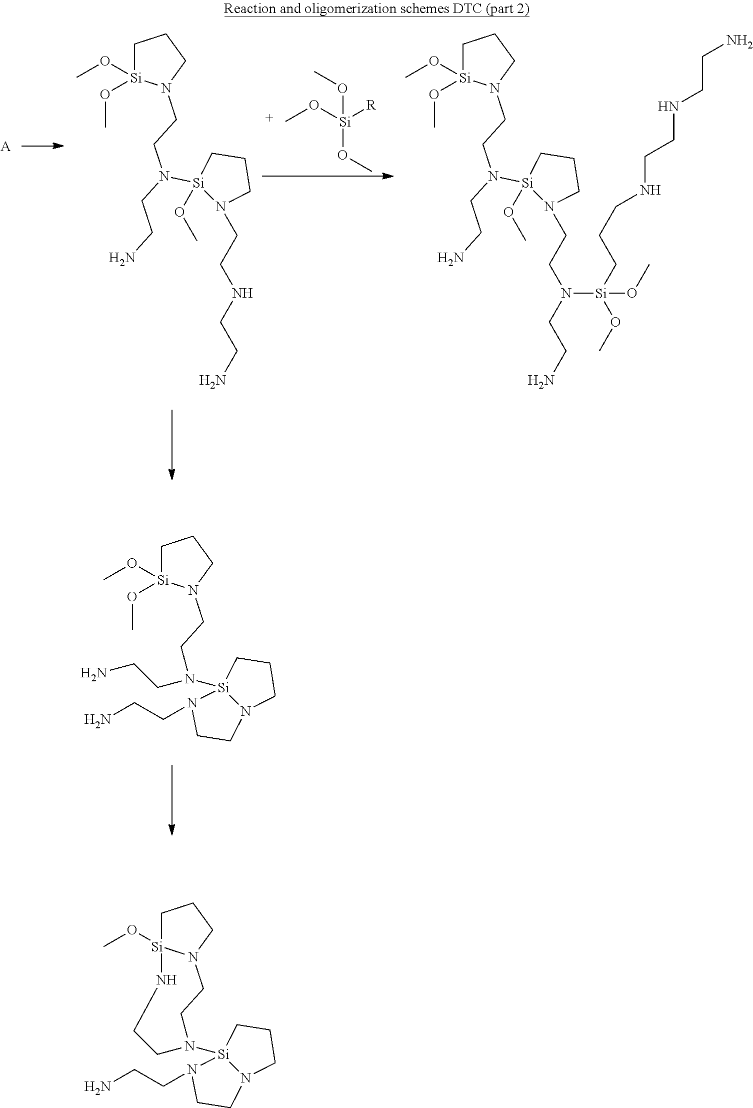

In the formulas of the invention, each residue R^{d} independently represents a saturated or unsaturated, optionally substituted hydrocarbon residue having 1 to 16 carbon atoms, preferably 1-12 carbon atoms, even more preferably 1-8 carbon atoms, still more preferably 1-6 carbon atoms, in particular 1-4 carbon atoms.

Preferably, each residue R^{d} independently represents
an optionally substituted alkyl, alkenyl or alkynyl residue
an optionally substituted cycloaliphatic residue, aromatic residue or aliphatic-aromatic residue, or
an optionally substituted heteroalicyclic residue or heteroaromatic residue,
each with 1 to 16 carbon atoms, more preferably with 1-12 carbon atoms, even more preferably with 1-8 carbon atoms, more preferably with 1-6 carbon atoms, in particular 1-4 carbon atoms.

In a particularly preferred embodiment, each residue R^{d} independently represents methyl, ethyl, n-, iso-propyl, n-, sec-, iso- or tert-butyl, octyl, iso-octyl, allyl, vinyl or phenyl. Further preferred are methyl, ethyl, n-propyl, iso-propyl, iso-butyl, octyl, iso-octyl, vinyl or phenyl. Most preferably, each residue R^{d} independently represents methyl or ethyl.

Each residue R^{c}, R^{e} and R^{g} independently represents H or a saturated or unsaturated, optionally substituted hydrocarbon residue having 1 to 16 carbon atoms, preferably 1-12 carbon atoms, more preferably 1-8 carbon atoms, even more preferably 1-6 carbon atoms, in particular 1-4 carbon atoms.

Preferably, each residue R^{c}, R^{e} and R^{g} independently represents
H or an optionally substituted alkyl, alkenyl or alkynyl residue
an optionally substituted cycloaliphatic residue, aromatic residue or aliphatic-aromatic residue, or
an optionally substituted heteroalicyclic residue or heteroaromatic residue,
each with 1 to 16 carbon atoms, more preferably with 1-12 carbon atoms, even more preferably with 1-8 carbon atoms, more preferably with 1-6 carbon atoms, in particular 1-4 carbon atoms.

In a particularly preferred embodiment, each residue R^{c}, R^{e} and R^{g} independently represents H, methyl, ethyl, n-, iso-propyl, n-, sec-, iso- or tert-butyl, octyl, iso-octyl, allyl, vinyl or phenyl. Further preferred are H, methyl, ethyl, n-propyl, iso-propyl, iso-butyl, octyl, iso-octyl, vinyl or phenyl. Most preferably, each R^{c}, R^{e} and R^{g} independently represents H or methyl.

Each residue R^{b} independently represents H, trialkylsilyl or a saturated or unsaturated, optionally substituted hydrocarbon residue having 1 to 16 carbon atoms, preferably 1-12 carbon atoms, more preferably 1-8 carbon atoms, even more preferably 1-6 carbon atoms, in particular 1-4 carbon atoms

Preferably, each residue R^{b} independently represents
H, trialkylsilyl or an optionally substituted alkyl, alkenyl or alkynyl residue
an optionally substituted cycloaliphatic residue, aromatic residue or aliphatic-aromatic residue, or
an optionally substituted heteroalicyclic residue or heteroaromatic residue,
each with 1 to 16 carbon atoms, more preferably with 1-12 carbon atoms, even more preferably with 1-8 carbon atoms, more preferably with 1-6 carbon atoms, in particular 1-4 carbon atoms.

In a particularly preferred embodiment, each residue R^{b} independently represents H, trialkylsilyl, methyl, ethyl, n-, iso-propyl, n-, sec-, iso- or tert-butyl, octyl, iso-octyl, allyl, vinyl or phenyl. Further preferred are H, trialkylsilyl, methyl, ethyl, n-propyl, iso-propyl, iso-butyl, octyl, iso-octyl, vinyl or phenyl.

The alkyl groups in the trialkylsilyl group are preferably, independently, methyl, ethyl, n-, iso-propyl, n-, sec-, iso- or tert-butyl, octyl, iso-octyl, allyl, vinyl or phenyl. Trialkylsilyl is further preferably trimethylsilyl, triethylsilyl, tripropylsilyl or tributylsilyl, most preferably trimethylsilyl and triethylsilyl. Most preferably, each residue R^{b} independently represents H, trimethylsilyl or methyl.

In the formulas of the present invention, o is preferably 1, 2 or 3, more preferably 2 or 3, particularly preferably 2. It is further preferred that R^{b} is H, trialkylsilyl or CH₃, and/or R^{c}═H and/or p=2 or 3, in particular p=3.

In a preferred embodiment of the invention, is Y═N(CR^{c}₂)ₒX or P(CR^{c}₂)ₒX, preferably N(CR^{c}₂)ₒXH, wherein R^{c}, o and X are as defined above, more preferably therein R^{c}═H, o=2 or 3 and/or X═O or NH.

In a preferred embodiment of the invention, (HX(CR^{c}₂)ₒY(CR^{c}₂)ₒX(CR^{c}₂)ₒ)₄₋ₚSiKₚ. or (HX(CR^{c}₂)ₒY(CR^{c}₂)ₒX(CR^{c}₂)ₒ)₄₋ₚSi(OR^{d})ₚ, respectively, is (CH₃O)₃Si(CH₂)₃NH(CH₂)₂NH(CH₂)₂NH₂, wherein R, X, Y, R^{c}, R^{d}, m, o and p are as defined in the present description.

The features and preferred embodiments mentioned above and those to be explained below may be combined in any combination without departing from the scope of the present invention. For example, in a preferred embodiment, the invention relates to a composition obtainable by mixing the components
(a) Crosslinker or crosslinker mixture, obtainable by reaction of (HX(CR^{c}₂)ₒY(CR^{c}₂)ₒX(CR^{c}₂)ₒ)₄₋ₚSiKₚ, preferably (HX(CR^{c}₂)ₒY(CR^{c}₂)ₒX(CR^{c}₂)ₒ)₄₋ₚSi(OR^{d})ₚ, wherein
   X, Y, K, R^{c}, R^{d} and o are as defined in the present patent application, and
   p=2 or 3,
(b) Metal catalyst and
(c) Amino silane.

In a particularly preferred embodiment of the invention, the composition is obtainable by mixing the above-mentioned components (a) to (c) and additionally the component
(d) a polyorganosiloxane of the formula HO—(SiR^{q}R^{r}O)ₛ—H, wherein each R^{q} and R^{r} independently represents a saturated or unsaturated, optionally substituted hydrocarbon residue having 1-16 carbon atoms and s is an integer from 5 to 5000.

Preferably, each R^{q} and R^{r} independently represents
an optionally substituted alkyl, alkenyl or alkynyl residue;
an optionally substituted cycloaliphatic residue, aryl residue or aralkyl residue; or an optionally substituted heteroalicyclic residue or heteroaryl residue, in each case having 1-16 carbon atoms.

The polyorganosiloxane undergoes polymerization and/or crosslinking to form a silicone composition.

In one embodiment, the invention relates to a composition obtainable by mixing components (a) to (c). Component (a) is obtainable by reaction (chemical reaction) of the starting components described under (a). Components (a) to (c) will usually already partially react with each other after mixing. In a preferred embodiment of the invention, the composition according to the invention comprises components (a) to (c).

Components (a), (b) and (c) are mixed, wherein (a) is the reaction mixture according to (a). The reaction product (a) may be worked up or purified, for example by-products may be separated or products isolated therefrom. As a rule, the reaction product (a) will be a mixture of various compounds.

The idealized product of the preferred reaction pathway of the reaction of (HX(CR^{c}₂)ₒY(CR^{c}₂)ₒX(CR^{c}₂)ₒ)₄₋ₚSiKₚ is a monomeric compound.

In a preferred embodiment of the invention, the composition according to the invention therefore comprises the components (a) at least one crosslinker of the formula (X(CR^{c}₂). Z(CR^{c}₂)ₒZ(CR^{c}₂)ₒ)Si, wherein X, Z, R^{c} and o are as defined here,
(b) at least one metal catalyst and
(c) at least one amino silane.

In the above formulas, the preferred and particularly preferred embodiments described are also preferred and particularly preferred.

For example, each R^{d} preferably independently represents a saturated or unsaturated, optionally substituted hydrocarbon residue having 1 to 12 carbon atoms, more preferably 1-8 carbon atoms, even more preferably 1-6 carbon atoms, in particular 1-4 carbon atoms.

Further preferred is that each residue R^{d} independently represents
an optionally substituted alkyl, alkenyl or alkynyl residue
an optionally substituted cycloaliphatic residue, aromatic residue or aliphatic-aromatic residue, or
an optionally substituted heteroalicyclic residue or heteroaromatic residue,
each with 1 to 16 carbon atoms, more preferably with 1-12 carbon atoms, even more preferably with 1-8 carbon atoms, more preferably with 1-6 carbon atoms, in particular 1-4 carbon atoms.

In a particularly preferred embodiment, each residue R^{d} independently represents methyl, ethyl, n-, iso-propyl, n-, sec-, iso- or tert-butyl, octyl, iso-octyl, allyl, vinyl or phenyl. Further preferred are methyl, ethyl, n-propyl, iso-propyl, iso-butyl, octyl, iso-octyl, vinyl or phenyl. Most preferably, each R^{d} independently represents methyl or ethyl.

Each residue R^{b} and R^{c} independently represents the groups described.

In the formulas of the present invention, o is preferably 1, 2 or 3, more preferably 2 or 3.

Preferably, the crosslinker in the composition according to the invention is

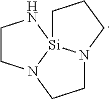 [SMILES: C1CN2CCN3CCN[Si]23C1]

In a particularly preferred embodiment of the invention, the composition comprises, in addition to the above-mentioned components (a) to (c), the component (d) a polyorganosiloxane of the formula HO—(SiR^{q}R^{r}O)ₛ—H, wherein each R^{q} and R^{r} independently represents a saturated or unsaturated, optionally substituted hydrocarbon residue having 1-16 carbon atoms and s is an integer from 5 to 5000.

Preferably, each R^{q} and R^{r} independently represents
an optionally substituted alkyl, alkenyl or alkynyl residue;
an optionally substituted cycloaliphatic residue, aryl residue or aralkyl residue; or an optionally substituted heteroalicyclic residue or heteroaryl residue, in each case having 1-16 carbon atoms.

As described above, each X in the formulas independently represents O, NR^{b}, S, or PR^{b}. Preferably, each X independently represents O or NR^{b}, more preferably O or NH, in particular O.

In a further embodiment, the composition according to the invention comprises
a crosslinker of the formula Si(R)ₘ(XR^{a})₄₋ₘ, wherein
each R and R^{a} independently represents
a saturated or unsaturated, optionally substituted hydrocarbon residue having 1 to 16 carbon atoms,
m is an integer from 0 to 2;
each X independently represents NR^{b} or O, wherein each R^{b} independently represents H, trialkylsilyl or a saturated or unsaturated, optionally substituted hydrocarbon residue having 1 to 16 carbon atoms, wherein at least two XR^{a} residues are covalently bonded to each other and additionally covalently bonded to a residue R.

For the purposes of the invention, “at least two” is understood to mean in particular two, three or four, i.e. two, three or four residues XR^{a} can be bonded to one another.

In the case of the residues R and/or XR^{a}, which are covalently bonded to each other, two H atoms of the residues are replaced by a covalent bond. For example, two methyl groups become an ethylene group or two —N(R)CH₃ groups can become an —N(R)—CH₂—CH₂—N(R) group. Instead of an alkyl residue, an alkanediyl residue is then present due to the covalent bond to a further residue and an alkanetriyl residue is present in the case of a covalent bond to two further residues.

In a preferred embodiment of the invention, in the formula Si(R)ₘ(XR^{a})₄₋ₘ, each residue R and R^{a} that is not covalently bonded to another residue R or R^{a} independently
an optionally substituted alkyl, alkenyl or alkynyl residue;
an optionally substituted cycloaliphatic residue, aromatic residue or aliphatic-aromatic residue; or
an optionally substituted heteroalicyclic residue or heteroaromatic residue, each having 1 to 16 carbon atoms.

Each residue R^{a} and R which is covalently bonded to another residue R or R^{a} preferably independently represents
an optionally substituted alkanediyl, alkenediyl or alkynediyl residue;
an optionally substituted cycloaliphatic residue, aromatic residue or aliphatic-aromatic residue; or
an optionally substituted heteroalicyclic residue or heteroaromatic residue, each having 1 to 16 carbon atoms.

Each residue R^{a} and R which is covalently bonded to two other residues R and/or R^{a} preferably independently represents
an optionally substituted alkanetriyl, alkentriyl or alkintriyl residue;
an optionally substituted cycloaliphatic residue, aromatic residue or aliphatic-aromatic residue; or
an optionally substituted heteroalicyclic residue or heteroaromatic residue, each having 1 to 16 carbon atoms.

In a preferred embodiment, the residues R and R^{a}, which are covalently bonded to each other, are obtained by replacing two H atoms by a covalent bond derived from the residues optionally substituted alkyl, alkenyl or alkynyl residue;
optionally substituted cycloaliphatic residue, aromatic residue or aliphatic-aromatic residue; or
optionally substituted heteroalicyclic residue or heteroaromatic residue, each with 1 to 16 carbon atoms.

The residues which have 1 to 16 carbon atoms preferably have 1-12 carbon atoms, more preferably 1-8 carbon atoms, even more preferably 1-6 carbon atoms, in particular 1-4 carbon atoms. The residues which have 1 to 12 carbon atoms preferably have 1-8 carbon atoms, more preferably 1-6 carbon atoms, in particular 1-4 carbon atoms.

In a particularly preferred embodiment, each residue R and/or R^{a} of the crosslinker of the formula Si(R)ₘ(XR^{a})₄₋ₘ which is not covalently bonded to another residue independently represents methyl, ethyl, n-, iso-propyl, n-, sec-, iso- or tert-butyl, or phenyl. Each residue R and R^{a} of the crosslinker which is covalently bonded to another residue is derived by replacing one H atom by a covalent bond from the residues methyl, ethyl, n-, sec-, iso- or tert-butyl, or phenyl.

As described above, each X independently represents NR^{b}, PR^{b} or O. Each residue R^{b} in the above formula independently represents H, trialkylsilyl or a saturated or unsaturated, optionally substituted hydrocarbon residue having 1 to 16 carbon atoms. R^{b} preferably has 1-12 carbon atoms, more preferably 1-8 carbon atoms, in particular 1-6 carbon atoms.

Preferably, each residue R^{b} in the above formula independently represents
H, trialkylsilyl or an optionally substituted alkyl, alkenyl or alkynyl residue;
an optionally substituted cycloaliphatic residue, aromatic residue or aliphatic-aromatic residue; or
an optionally substituted heteroalicyclic residue or heteroaromatic residue, in each case having 1 to 16 carbon atoms, further preferably having 1-12 carbon atoms, even more preferably having 1-8 carbon atoms, most preferably having 1-6 carbon atoms

In a preferred embodiment, R^{b} represents H, trialkylsilyl, methyl, ethyl, n-, iso-propyl, n-, sec-, iso- or tert-butyl, octyl, iso-octyl, allyl, vinyl or phenyl. H, trialkylsilyl, methyl, ethyl, n-propyl, iso-propyl, iso-butyl, octyl, iso-octyl, vinyl and phenyl are further preferred. Most preferred is R^{b}═H or trimethylsilyl.

In a preferred embodiment of the invention, the at least two residues R^{a} which are covalently bonded to one another can be bonded to one another via a C—C bond or via heteroatoms. These can be the heteroatoms X of the residues XR^{a} in the formula Si(R)ₘ(XR^{a})₄₋ₘ or heteroatoms of substituents of the residues. Preferably, the at least two residues R^{a} are covalently bonded to one another via a C—C bond, a C—N bond or a C—O-bond, particularly preferably via a C—C bond or a C—N bond.

In a preferred embodiment of the invention, in the formula Si(R)ₘ(XR^{a})^{4-m} of the crosslinker, m=1 or 2 and the at least two residues R^{a} which are covalently bonded to each other are additionally covalently bonded to a residue R. This has the advantage that the group is not volatile, but remains bound to the polymer and thus no compound resulting from the leaving group is emitted from the silicone rubber compound obtained.

In yet another preferred embodiment, the formula
Si(R)ₘ(XR^{a})₄₋ₘ=1 and three residues R^{a} are covalently bonded to each other. This results in a leaving group having a higher molecular weight with several HXR^{a} groups, which is hardly emitted. It is further preferred that the three residues R^{a} that are covalently bonded to each other are also covalently bonded to the residue R. This has the advantage already described above that the leaving group remains bound to the polymer and is therefore not volatile.

In still another preferred embodiment, in the formula Si(R)ₘ(XR^{a})^{4-m} m is 1, three residues R^{a} are covalently bonded to each other and bonded to the residue R. It is also preferred that in the formula Si(R)ₘ(XR^{a})₄₋ₘ m is 2, two R^{a} residues are covalently bonded to each other and bonded to one residue R.

In a further particularly preferred embodiment, mixtures of the crosslinkers described are used for the compositions according to the invention

In a particularly preferred embodiment of the invention, R represents an optionally substituted, straight-chain or branched C1 to C12 alkyl group, in particular an optionally substituted, straight-chain or branched C1 to C8 alkyl group, an optionally substituted, straight-chain or branched C2 to C12-alkenyl group, in particular an optionally substituted, straight-chain or branched C2 to C8 alkenyl group, an optionally substituted C4 to C10 aryl group or an optionally substituted C5 to C15 aralkyl group. In a particularly preferred embodiment, R represents residues selected from the group consisting of methyl, ethyl, n- and iso-propyl, and n-, sec-, iso- and tert-butyl, vinyl and phenyl or an allyl residue. Most preferably, R is methyl or ethyl.

R^{c} is particularly preferably H or an optionally substituted, straight-chain or branched C1 to C12 alkyl group, in particular an optionally substituted, straight-chain or branched C1 to C8 alkyl group, an optionally substituted, straight-chain or branched C2 to C12 alkenyl group, in particular an optionally substituted, straight-chain or branched C2 to C8 alkenyl group, an optionally substituted C4 to C10 aryl group or an optionally substituted C5 to C15 aralkyl group. In a particularly preferred embodiment, R^{c} represents a residue selected from the group consisting of H, methyl, ethyl, n- and iso-propyl, and n-, sec-, iso- and tert-butyl, vinyl, allyl and phenyl. Most preferred is R^{c}═H, methyl or ethyl.

In a preferred embodiment of the invention, the crosslinker is a compound of the formula

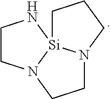 [SMILES: C1CN2CCN3CCN[Si]23C1]

The composition according to the invention preferably has less than 1 wt.-% mass loss after curing, based on the total weight of the composition, in particular less than 0.75 wt.-%, even more preferably less than 0.5 wt.-%, based on the total weight of the composition (mass loss measured according to DIN EN ISO 10563)

The composition according to the invention further comprises a metal catalyst. The metal catalyst catalyzes the curing of the composition by catalyzing the crosslinking of OH group-bearing polyorganosiloxanes (silicones) with the crosslinker in the presence of water or humidity. After curing, a silicone rubber compound according to the invention is obtained. The metal catalyst is preferably a compound comprising a metal or a semi-metal and an organic residue. Further preferably, the metal catalyst is an organometallic compound.

The metal of the metal catalyst is preferably selected from the group consisting of s- and p-block metals, d- and f-block transition metals, lanthanide and actinide metals and semimetals, in particular from the group consisting of metals of the first, second, third, fourth, fifth, eighth, tenth and eleventh subgroups and metals of the first, second, third, fourth and fifth main groups. Further preferably, the metal of the metal catalyst is selected from the group consisting of Na, Zn, Sc, Nd, Ti, Zr, Hf, V, Fe, Pt, Cu, Ga, Ca, Sn and Bi, preferably selected from the group consisting of Ti, Zr, Zn, Ca, Sn and Bi.

In a further preferred embodiment, the metal catalyst contains tin. Particularly preferred catalysts are dialkyltin(II) salts such as dialkyltin(II) carboxylates, e.g. dibutyltin dilaurate.

In another preferred embodiment, the metal catalyst does not contain tin. Such tin-free catalysts have the advantage that toxic tin, in particular from organotin compounds, is avoided. Therefore, the metal of the metal catalyst is then preferably selected from the group consisting of Na, Zn, Sc, Nd, Ti, Zr, Hf, V, Fe, Pt, Cu, Ga, Ca, and Bi, preferably selected from the group consisting of Ti, Zr, Zn, Ca, and Bi.

In a preferred embodiment of the invention, the composition comprises as metal catalyst a metal siloxane-silanol(-ate) compound (=metal siloxane-silanol/silanolate compound) also referred to as “M3S” compound. These M3S compounds are described in EP 3 392 313 A1 and can be advantageously used as catalysts in the compositions of the present invention

In a preferred embodiment of the invention, the composition comprises as metal catalyst a metal siloxane, in particular a metal siloxane of the formula R*_{A}Si_{B}O_{C}M_{D}, wherein
each R* is independently selected from the group consisting of optionally substituted C1 to C20 alkyl, optionally substituted C3 to C6 cycloalkyl, optionally substituted C2 to C20 alkenyl, optionally substituted C6 to C10 aryl, —OH and —O—(C1 to C20 alkyl), wherein
M is the metal,
A is an integer from 4 to 19,
B is an integer from 4 to 10,
C is an integer from 8 to 30, and
D is an integer from 1 to 8.

The metal siloxane is preferably a metal silsesquioxane, in particular a polyhedral metal silsesquioxane. A polyhedral metal silsesquioxane is understood to be a metal silsesquioxane in which silicon and metal atoms at least partially occupy the corners of a polyhedron, for example a cube.

The metal silsesquioxane is particularly preferably a polyhedral titanium and/or zirconium silsesquioxane. An example is given below:

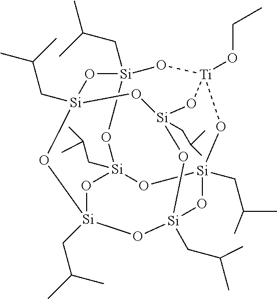

Furthermore, the composition according to the invention contains, as component (c), an amino silane which can function in the composition, inter alia, as an adhesion promoter.

An amino silane is an organic compound that contains a silicon atom and an amino group. The amino group can optionally be substituted. In particular, the amino group may be a primary, secondary or tertiary amino group.

In a preferred embodiment of the composition according to the invention, the amino silane is
(a) a compound of the formula (X)₃Si—R^{E}—N(R^{F})R^{G},
wherein each X is independently selected from the group consisting of —OMe, —OEt, —OⁱPr, —OⁿPr, —OⁿBu, —O^{sec}Bu, —O^{iso}Bu, —O^{t}Bu and —OPh
R^{E} is —(CH₂)ₛ—, wherein s is an integer from 1 to 10,
R^{F} is H, an optionally substituted C1 to C16 alkyl group or R^{(I)},
R^{G} is an optionally substituted C1 to C16 alkyl group, R^{I} or —C(O)—R^{(H)},
wherein R^{F} means H only if R^{G} is —C(O)—R^{H}, and
wherein R^{H} is an optionally substituted, straight-chain or branched C1 to C16 alkoxy group, —O—R^{I}, an optionally substituted, straight-chain or branched C1 to C16 alkyl group, R^{I} or —CHMe-O—C(O)-Me,
or wherein R^{F} and R^{G} together with the atom to which they are bonded form an optionally substituted heterocyclic ring system having 3 to 14 carbon atoms and 1 to 5 heteroatoms selected from the group consisting of N and O, and
each R^{I} independently denotes an optionally substituted cyclic ring system having 4 to 14 carbon atoms or an optionally substituted aromatic group having 4 to 14 carbon atoms,
or oligomers or polymers thereof,

Or (b) is a heterocyclic amino silane, wherein a silicon atom and a nitrogen atom are directly linked to each other.

In a particularly preferred embodiment, the amino silane is selected from the group consisting of 3-aminopropyltriethoxysilane, 3-aminopropyltrimethoxysilane, aminoethylaminopropyltrimethoxysilane, butylaminopropyltriethoxysilane, butylaminopropyltrimethoxysilane, propylaminopropyltriethoxysilane, propylaminopropyltrimethoxysilane, N-cyclohexyl-3-aminopropyltrimethoxysilane, N-cyclohexyl-3-aminopropyltriethoxysilane, diethylaminopropyltrimethoxysilane, dipropylaminopropyltrimethoxysilane, dibutylaminopropyltrimethoxysilane, trimethoxypropylsilylacetoxypropionic acid amide, N,N′-bis(trimethoxysilylpropyl)urea, N,N′-bis(triethoxysilylpropyl)urea, tris(triethoxysilylpropyl)diethylenetriurea, dimethylaminopropyltrimethoxysilane, 1,3,5-tris(trimethoxysilylpropyl)isocyanurate, N-methyl(3-trimethoxysilyl)propyl)carbamate, N-ethyl(3-triethoxysilyl)propyl)carbamate, N-(2-aminoethyl)-3-aminopropyltrimethoxysilane and mixtures thereof.

In a further preferred embodiment of the invention, the composition comprises as amino silane a heterocyclic amino silane, wherein a silicon atom and a nitrogen atom are directly linked to each other.

The heterocyclic amino silane may preferably be a heterocyclic organosilane as described in EP 3 613 803 A1, wherein the heteroatom is preferably a nitrogen atom.

In a particularly preferred embodiment, the heterocyclic amino silane is a compound of the formula

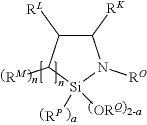

wherein a is 0.1 or 2;
n=0-6;
each of R^{K}, R^{L}, R^{M}, R^{O}, R^{P} and R^{Q} is independently H or an optionally substituted, straight-chain or branched C1 to C20 alkyl group, an optionally substituted, straight-chain or branched C2 to C20 alkenyl group, an optionally substituted C3 to C20 cycloalkyl group, an optionally substituted C4 to C20 cycloalkenyl group, an optionally substituted, straight-chain branched or cyclic C4 to C20 alkynyl group or an optionally substituted, straight-chain or branched C2 to C20 heteroalkyl group, an optionally substituted, straight-chain, branched or cyclic C3 to C20 heteroalkyl group or an optionally substituted, straight-chain, branched or cyclic C3 to C20 heteroalkyl group or an optionally substituted C4 to C14 aryl or heteroaryl group, or two residues R^{K}, R^{L}, R^{M}, R^{O}, R^{P} and R^{Q} together form a 5- to 8-membered ring.

The parameter a in (R^{p})ₐ and (OR^{Q})₂₋ₐ represents a ratio of alkoxy residues OR^{Q} to residues R^{p} as defined herein. Here, a can have values from 0 to 2. If a=0, the corresponding heterocyclic organosilane contains no residue R^{p} and two residues OR^{Q}. The parameter a can also be 1. In this case, one residue R^{p} and one residue OR^{Q} are directly bound to the silicon atom of the heterocyclic organosilane. If a=2, only residues R^{p} and no residues OR^{Q} are linked to the silicon atom.

The residues (R^{M})ₙ in formula (III) are each directly related to the ring size, which is determined by the parameter n. The possible number of residues on the ring atoms is also adjusted here by the value n. For example, if there is a 6 ring, n=2 and the number of residues R^{c} or R^{C} is adjusted accordingly to 2. In this way, each ring atom can carry one residue.

The heterocyclic amino silane can carry different residues on each ring atom, each R^{K}, R^{L}, R^{M}, R^{O}, R^{P} and R^{Q} of the formula (III) is independently H or an optionally substituted, straight-chain or branched C1 to C20 alkyl group, an optionally substituted, straight-chain or branched C2 to C20 alkenyl group, an optionally substituted C3 to C20 cycloalkyl group, an optionally substituted C4 to C20 cycloalkenyl group, an optionally substituted, straight-chain, branched or cyclic C4 to C20 alkynyl group or an optionally substituted, straight-chain or branched C2 to C20 heteroalkyl group, an optionally substituted, straight-chain, branched or cyclic C3 to C20 heteroalkenyl group or an optionally substituted C4 to C14 aryl or heteroaryl group. Preferably, each of R^{K}, R^{L}, R^{M}, R^{O}, R^{P} and R^{Q} is independently H, or an optionally substituted straight-chain or branched C1 to C10 alkyl group, an optionally substituted straight-chain or branched C2 to C10 alkenyl group, an optionally substituted straight-chain or branched C2 to C10 heteroalkyl group, an optionally substituted C3 to C10 cycloalkyl group, or an optionally substituted C4 to C8 aryl or heteroaryl group. Most preferably, each of R^{K}, R^{L}, R^{M}, R^{O}, R^{P} and R^{Q} is independently H, an optionally substituted straight-chain or branched C1 to C8 alkyl group, an optionally substituted straight-chain or branched C2 to C8 alkenyl group, an optionally substituted straight-chain or branched C4 to C8 heteroalkyl group, an optionally substituted C4 to C6 cycloalkyl group or an optionally substituted C5 to C6 aryl or heteroaryl group.

Particularly preferred heterocyclic amino silanes are substituted or unsubstituted, in particular unsubstituted N-n-butyl-1-aza-2,2-dimethoxy-2-silacyclopentane ((BDC), CAS No. 618914-44-6), 2,2-diethoxy-1-(3-triethoxysilylpropyl)aza-2-silacyclopentane ((TESPDC), CAS No. 1184179-50-7) and/or 2,2-diethoxy-1-(trimethylsilyl)aza-2-silacyclopentane ((TMS)DEC), CAS No. 21297-72-3), BnDC of the following structure (CAS No.: 2411737-55-6):

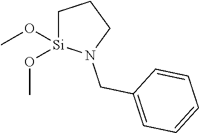 [SMILES: CO[Si]1(OC)CCCN1Cc1ccccc1]

In a preferred embodiment, the composition according to the invention contains an amino silane in an amount, based on the total weight of the composition, of 0.1-3 wt.-%, preferably 0.2-2 wt.-%, particularly preferably 0.3-1.5 wt.-%.

The composition according to the invention preferably additionally comprises a polyorganosiloxane of the formula HO—(SiR^{q}R^{r}O)ₛ—H, wherein
each R^{q} and R^{r} independently represents
an optionally substituted alkyl, alkenyl or alkynyl residue;
an optionally substituted cycloaliphatic residue, aryl residue or aralkyl residue; or an optionally substituted heteroalicyclic residue or heteroaryl residue;
and s is an integer from 5 to 5000.

If the composition according to the invention contains a polyorganosiloxane of the formula HO—(SiR^{q}R^{r}O)ₛ—H, an RTC-1 silicone rubber compound is present which can cure in the presence of water. If the composition according to the invention does not contain a polyorganosiloxane, an RTC-2 composition is present to which a polyorganosiloxane must be added before curing.

One polyorganosiloxane contained in the composition is a α,ω-dihydroxyl-terminated polyorganosiloxane. In addition to homopolymeric α,ω-dihydroxyl-terminated polydiorganosiloxanes, heteropolymeric α,ω-dihydroxyl-terminated polydiorganosiloxanes with different organic substituents can also be used, wherein both copolymers of monomers with similar organic substituents on a silicon atom and copolymers of monomers with different organic substituents on a silicon atom are comprised, e.g. those with mixed alkyl, alkenyl and/or aryl substituents The preferred organic substituents comprise straight-chain and branched alkyl groups with 1 to 8 carbon atoms, in particular methyl, ethyl, n- and iso-propyl, and n-, sec- and tert-butyl, vinyl and phenyl. In the individual organic substituents, individual or all carbon-bonded hydrogen atoms can be substituted by conventional substituents such as halogen atoms or functional groups such as hydroxyl and/or amino groups. For example, α,ω-dihydroxyl-terminated polydiorganosiloxanes with partially fluorinated or perfluorinated organic substituents can be used or α,ω-dihydroxyl-terminated polydiorganosiloxanes with organic substituents, substituted by hydroxyl and/or amino groups, on the silicon atoms are used.

Preferred examples of an organosilicone compound are α,ω-dihydroxyl-terminated polydialkylsiloxanes, such as α,ω-dihydroxyl-terminated polydimethylsiloxanes, α,ω-dihydroxyl-terminated polydiethylsiloxanes or α,ω-dihydroxyl-terminated polydivinylsiloxanes, as well as α, ω-dihydroxyl-terminated polydiarylsiloxanes, such as α,ω-dihydroxyl-terminated polydiphenylsiloxanes.

In a preferred embodiment, each R^{q} and R^{r} independently represents an optionally substituted, straight-chain or branched C1 to C16 alkyl group, an optionally substituted, straight-chain or branched C2 to C16 alkenyl group or an optionally substituted C4 to C14 aryl group.

In a further preferred embodiment, in the polyorganosiloxane HO—(SiR^{q}R^{r}O)ₛ—H s is an integer from 5 to 3500, more preferably from 10 to 3500, still more preferably from 100 to 3000, in particular from 800 to 2000, most preferably from 1000 to 1800.

In a further embodiment, the polyorganosiloxane HO—(SiR^{q}R^{r}O)ₛ—H has a weight average molecular weight M_{w} of from 400 to 5,000,000, in particular from 3,000 to 2,500,000, from 15,000 to 1,000,000, from 30,000 to 750,000, from 50,000 to 500,000 or from 110,000 to 150,000

In a preferred embodiment, the one polyorganosiloxane HO—(SiR^{q}R^{r}O)ₛ—H has a kinematic viscosity at 25° C. of from 20 to 350000 cSt or from 20000 to 100000 cSt or from 20000 to 90000 cSt or from 20000 to 80000 cSt.

In a particularly preferred embodiment, the composition according to the invention comprises a polyorganosiloxane HO—(SiR^{q}R^{r}O)ₛ—H, wherein R^{l} and R^{m} are independently selected from the group consisting of methyl-, ethyl-, propyl-, butyl-, trifluoromethyl-, vinyl-, allyl-, butenyl-, phenyl- and naphthyl-.

In a particularly preferred embodiment, the composition according to the invention comprises a polyorganosiloxane HO—(SiR^{q}R^{r}O)ₛ—H, wherein the polyorganosiloxane is α,ω-dihydroxy-dimethyl-polysiloxane.

The weight ratio of the polyorganosiloxane, in particular the α,ω-dihydroxyl-terminated polydialkylsiloxane, to the crosslinker is preferably 100:1-2:1, particularly preferably 50:1 to 5:1, especially 15:1-6:1.

The composition according to the invention can contain the compound with the formula HO—(SiR^{q}R^{r}O)ₛ—H and the crosslinker, each independently of the other, in the form of a prepolymer. The prepolymer is a reaction product of the two components. These reactions are known and are also referred to as end capping, as described, for example, in WO 2016/146648 A1.

In addition to the components described, the composition according to the invention may optionally contain further ingredients/components, in particular conventional additives such as fillers, plasticizers, reactive diluents, colorants, thixotropic agents, rheological additives, wetting agents, UV stabilizers, antioxidants, desiccants, etc. Preferably, the compositions according to the invention contain at least one further ingredient.

The composition according to the invention may further preferably contain plasticizers. Preferred plasticizers are end-capped polyethylene glycols, e.g. polyethylene or polypropylene glycol dialkyl ethers, wherein the alkyl residue has one to four carbon atoms, in particular dimethyl and diethyl ethers of diethylene glycol and dipropylene glycol. Preferred plasticizers are also diurethanes, which can be produced, for example, by reacting diols with OH end groups with monofunctional isocyanates. In a preferred embodiment of the invention, polyalkylsiloxanes, particularly preferably polydimethylsiloxane, are used as plasticizers.

The compositions preferably contain plasticizers in an amount of 2 to 50 wt.-%, preferably in an amount of 10 to 40 wt.-%, particularly preferably in an amount of 20 to 35 wt.-%, in each case based on the total weight of the composition. If a mixture of several plasticizers is used, the quantities given refer to the total quantity of plasticizer in the composition.

Reactive diluents can also be added if the viscosity of the composition is to be further reduced. Suitable reactive diluents are compounds that are miscible with the composition and have at least one group that is reactive with the polymer. Preferably, the reactive diluent has at least one functional group that reacts with moisture or atmospheric oxygen. Examples are isocyanate groups, silyl groups or unsaturated groups such as vinyl groups. To produce preferred reactive diluents, corresponding polyol components, for example, can be reacted with an at least difunctional isocyanate.

The composition according to the invention may further contain fillers. Suitable fillers include chalk, lime powder, precipitated and/or fumed silica, zeolites, bentonites, magnesium carbonate, alumina, tallow, titanium oxide, iron oxide, zinc oxide, quartz, sand, mica and other powdered or ground minerals. Furthermore, organic fillers can also be used, in particular wood fibers, wood flour, sawdust, cellulose, cotton and chaff.

In a particularly preferred embodiment of the invention, silica is added to the composition as a filler, in untreated and/or treated, preferably hydrophobized form, particularly preferably fumed silica, also referred to as fumed silicon dioxide. In a particularly preferred embodiment of the invention, a mixture of untreated and hydrophobized silica is added to the composition as a filler.

The fillers are preferably used in an amount of 1 to 60 wt.-%, particularly preferably 2 to 20 wt.-%, and very particularly preferably 5 to 15 wt.-%, in each case based on the total weight of the composition. Mixtures of several fillers can also be used. In this case, the quantities given refer to the total amount of filler in the composition.

For some applications, additives or fillers that impart thixotropy to the composition are preferred. Such fillers are also described as rheological aids, e.g. hydrogenated castor oil, fatty acid amides or swellable plastics.

In addition to the amino silane, the composition according to the invention may contain additional adhesion promoters. Suitable adhesion promoters here are, for example, resins, e.g. aliphatic or petrochemical resins and modified phenolic resins as well as terpene oligomers. Such resins are used, for example, as adhesion promoters for pressure-sensitive adhesives and coating materials. Terpene-phenol resins are also suitable.

Preferably, the composition contains at least one stabilizer. All stabilizers that have previously been used in the preparation of similar compositions can be used as stabilizers. Examples of stabilizers are phosphorus compounds in all oxidation states. The stabilizer is particularly preferably a phosphorus compound, such as phosphoric acid monoesters, phosphoric acid diesters or phosphonic acids; octyl phosphonic acid is particularly preferred.

The composition according to the invention can also be stabilized against penetrating moisture by desiccants in order to further increase the shelf life. All compounds that react with water to form inert groups with respect to the reactive groups present in the composition are suitable as desiccants. Suitable desiccants include isocyanates and silanes, for example vinyl silanes such as 3-vinylpropyltriethoxysilane, oximosilanes or carbamatosilanes. However, the use of methyl, ethyl or vinyl trimethoxysilane, tetramethyl or ethyl ethoxysilane is also possible. Vinyltrimethoxysilane and tetraethoxysilane are particularly preferred.

In a preferred embodiment of the invention, the components of the composition are mixed together, in particular in the form of a single-phase mixture.

The invention also relates to a process for preparing the composition according to the invention, wherein the components (a), (b) and (c), and optionally further components, in particular (d), are mixed together.

The invention further relates to the use of the composition according to the invention for the production of a sealant, glue, coating agent, jointing material, potting compound, adhesive and/or paint.

The invention also relates to a silicone rubber compound obtainable by curing the composition according to the invention, preferably in the presence of water, for example in the form of humidity. The obtainable silicone rubber compound can be a sealant, glue, coating agent, jointing material, potting compound or adhesive and it can be used in paints or for the production of paints.

The invention also relates to a process for producing a silicone rubber compound by curing the composition according to the invention in the presence of water, for example in the form of humidity.

It is understood that the above-mentioned features and the features to be explained below can be used not only in the combinations indicated, but also in other combinations or on their own, without going beyond the scope of the present invention. The aforementioned advantages of features or of combinations of several features are merely exemplary and can take effect alternatively or cumulatively. The combination of features of different embodiments of the invention or of features of different claims is possible in deviation from the selected references of the claims.

The following examples are to further explain the invention without limiting the invention thereto.

### EXAMPLES

The change in mass was determined in accordance with DIN EN ISO 10563. The comparative examples are reference compositions based on sealants established on the market.

### Example 1: DTC

### Two-Component Sealant (RTC2):

A silicone rubber compound is produced according to the following formulation:

### Component A:

496 g alpha-omega hydroxyl-terminated polydimethylsiloxane with a viscosity of 80,000 cSt (centistokes)
372 g chalk Socal U
124 g chalk BLH 3

### Component B:

61.3 g polydimethylsiloxane with viscosity 100 cSt
13.0 g DTC
5.3 g highly dispersed silica hydrophilic
14.2 g adhesion promoter BDC (1-butyl-2,2-dimethoxy-1,2-azasilolidine)
0.6 g catalyst dibutyltin dilaurate

Components A and B are mixed in a ratio of 10:1 and processed immediately.

After being exposed to air after application the sealant has:
a skin formation time of 20 min
a bonding time of 40 min
early exposure after 50 min
good notch resistance after 24 h
a Shore hardness A of 22 after 4 days
complete curing (9 mm layer thickness) after 4 days
good adhesion to wood, painted wood, varnished wood, aluminum, powder-coated aluminum, glass, PVC, polyamide, steel, concrete, polyethylene and Plexiglas
a mass loss of 0.40% (according to DIN 10563)

### Comparative Example 1: Methyl-tris(2-pentanonoxime)silane/vinyl-tris(2-pentanonoxime)silane

### 1-Component Sealant (RTC1):

A silicone rubber compound is produced according to the following formulation:
530 g alpha-omega hydroxyl-terminated polydimethylsiloxane with a viscosity of 80,000 cSt
312.8 g polydimethylsiloxane with viscosity 100 cSt
13.0 g vinyl-tris(2-pentanonoxime)silane
30.0 g methyl-tris(2-pentanonoxime)silane
105 g highly dispersed silica hydrophilic
8.0 g adhesion promoter 5201 (mixture of aminoethylaminopropyltrimethoxysilane and alpha-omega hydroxyl-terminated polydimethylsiloxane)
1.2 g catalyst 271 (mixture of dioctyltin oxide and tetrapropoxysilane)

After being exposed to air after application the sealant has:
a skin formation time of 9 min
a bonding time of 23 min
early exposure after 170 min
good notch resistance after 24 h
a Shore hardness A of 26 after 4 days
complete curing (9 mm layer thickness) after 5 days
good adhesion to glass, wood, painted wood, varnished wood, aluminum, PVC, polyamide, steel, concrete
a mass loss of 3.8% (according to DIN 10563)

### Comparative Example 2: Methyl-tris(2-pentanonoxime)silane/vinyl-tris(2-pentanonoxime)silane

### 2-Component Sealant (RTC2):

A silicone rubber compound is produced according to the following formulation:

### Component A:

361 g alpha-omega hydroxyl-terminated polydimethylsiloxane with a viscosity of 80,000 cSt
225 g polydimethylsiloxane with viscosity 100 cSt
150 g chalk Socal U
150 g chalk BLH 3
63 g highly dispersed silica hydrophilic

### Component B:

39.2 g polydimethylsiloxane with viscosity 100 cSt
31.0 g methyl-tris(2-pentanonoxime)silane
8.0 g vinyl-tris(2-pentanonoxime)silane
10.0 g highly dispersed silica hydrophilic
8.0 g adhesion promoter 5201
0.8 g catalyst 271 (mixture of dioctyltin oxide and tetrapropoxysilane)

Components A and B are mixed in a ratio (weight) of 10:1 and processed immediately.

After being exposed to air after application the sealant has:
a skin formation time of 7 min
a bonding time of 70 min
early exposure after 100 min
good notch resistance after 24 h
a Shore hardness A of 20 after 4 days
complete curing (9 mm layer thickness) after 2 days
good adhesion to glass, wood, painted wood, varnished wood, aluminum, PVC, polyamide, steel, concrete and in some cases Plexiglas
a mass loss of 4.05% (according to DIN 10563)

The above examples show that the mass loss is significantly reduced compared to the known silicone rubber compounds (0.40 wt % in example 1 compared to 3.8-4 wt.-% of conventional silicone rubber compounds). In addition, adhesion to polyethylene and Plexiglas is improved.

1.-15. (canceled)

16. A composition for a silicone rubber, the composition comprising:
a crosslinker mixture, wherein the crosslink mixture is obtainable by reaction of: (HX(CR^{c}₂)ₒY(CR^{c}₂)ₒX(CR^{c}₂)ₒ)₄₋ₚSiKₚ, wherein
X, at each occurrence, is independently O, NR^{b}, S, or PR^{b};
R^{b}, at each occurrence, is independently hydrogen, trialkylsilyl, or a saturated or unsaturated hydrocarbon;
Y, at each occurrence, is independently a C—C bond, CR^{c}₂, O, NR^{e} or PR^{e};
R^{c}, at each occurrence, is independently hydrogen or a saturated or unsaturated hydrocarbon; and
R^{e}, at each occurrence, is independently H or a saturated or unsaturated hydrocarbon;
K, at each occurrence, is independently Cl, OR^{d} or ON═CR^{g}₂;
R^{d}, at each occurrence, is independently a saturated or unsaturated hydrocarbon; and
R^{g}, at each occurrence, is independently a saturated or unsaturated hydrocarbon;
o, at each occurrence, is independently an integer from 1 to 8; and
p, at each occurrence, is independently 2 or 3;
a metal catalyst; and
amino silane.

17. The composition of claim 16, wherein R^{b} is a substituted hydrocarbon chain having 1-16 carbon atoms.

18. The composition of claim 16, wherein R^{c} is a substituted hydrocarbon chain having 1-16 carbon atoms.

19. The composition of claim 16, wherein R^{e} is a substituted hydrocarbon chain having 1-16 carbon atoms.

20. The composition of claim 16, wherein R^{d} is a substituted hydrocarbon chain having 1-16 carbon atoms.

21. The composition of claim 16, wherein R^{g} is a substituted hydrocarbon chain having 1-16 carbon atoms.

22. The composition of claim 16, wherein o is independently an integer from 1 to 3 and p is 3.

23. The composition of claim 16, wherein R^{b} is H, trialkylsilyl or methyl and R^{c} is hydrogen.

24. The composition of claim 16, wherein R^{d}, at each occurrence, is independently methyl, ethyl, n-propyl, iso-propyl, iso-butyl, octyl, iso-octyl, vinyl or phenyl residue.

25. The composition of claim 16, characterized in that Y═N(CR^{c}₂)ₒXH, wherein R^{c} is hydrogen, o is 2, and X is O or NR^{b}.

26. The composition of claim 16, wherein (HX(CR^{c}₂)ₒY(CR^{c}₂)ₒX(CR^{c}₂)ₒ)₄₋ₚSiKₚ is (CH₃O)₃Si(CH₂)₃NH(CH₂)₂NH(CH₂)₂NH₂.

27. The composition of claim 16, wherein the metal of the metal catalyst is selected from the group consisting of Na, Zn, Sc, Nd, Ti, Zr, Hf, V, Fe, Pt, Cu, Ga, Ca, Sn or Bi.

28. The composition of claim 16, wherein the composition is obtainable by additional mixing with a polyorganosiloxane, wherein the polyorganosiloxane has the formula HO—(SiR^{q}R^{r}O)ₛ—H, wherein
R^{q} and R^{r}, at each occurrence, is independently a saturated or unsaturated hydrocarbon with 1-16 carbon atoms; and
s is an integer from 5 to 5000.

29. The composition of claim 16, wherein R^{q} and R^{r}, at each occurrence, is independently an alkyl, alkenyl, alkynyl, cycloaliphatic, aryl, aralkyl, heteroalicyclic, or heteroaryl residue, having 1-16 carbon atoms.

30. A composition to be cured into silicone rubber, comprising
at least one crosslinker of the formula (X(CR^{c}₂)ₒZ(CR^{c}₂)ₒZ(CR^{c}₂)ₒ)Si, wherein
Z, at each occurrence, is independently N, P, N(CR^{c}₂)ₒX, or P(CR^{c}₂)ₒX;
X, at each occurrence, is independently O, NR^{b}, S, or PR^{b};
R^{c}, at each occurrence, is independently hydrogen or a saturated or unsaturated hydrocarbon; and
o, at each occurrence, is independently an integer from 1 to 8;
at least one metal catalyst; and
at least one amino silane.

31. The composition to be cured into silicone rubber of claim 30, wherein the crosslinker comprises

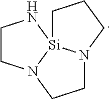 [SMILES: C1CN2CCN3CCN[Si]23C1]

32. The composition to be cured into silicone rubber of claim 30, wherein the composition further comprises:
a polyorganosiloxane of the formula HO—(SiR^{q}R^{r}O)ₛ—H, wherein R^{q} and R^{r}, at each occurrence, is independently a saturated or unsaturated hydrocarbon chain having 1-16 carbon atoms and s is an integer from 5 to 5000.

33. The composition to be cured into silicone rubber of claim 30, wherein R^{q} and R^{r}, at each occurrence, is independently an alkyl, alkenyl, alkynyl, cycloaliphatic, aryl, aralkyl, heteroalicyclic, or heteroaryl residue, having 1-16 carbon atoms.

34. The composition to be cured into silicone rubber of claim 30, wherein the composition is used for the production of a sealant, glue, coating agent, jointing material, potting compound, adhesive or paint.

35. The composition to be cured into silicone rubber of claim 30, wherein said silicone rubber compound obtainable by curing the composition in the presence of humidity.
